(19) United States
(12) Patent Application Publication
(10) Pub. No.: US 2023/0292157 A1
(43) Pub. Date: Sep. 14, 2023

(54) LOCAL 5G MONITORING SYSTEM AND ABNORMAL STATE DETECTION METHOD THEREOF

(71) Applicant: ANRITSU CORPORATION, Kanagawa (JP)

(72) Inventors: Mitsuhiro USUBA, Kanagawa (JP); Atsushi FURUKI, Kanagawa (JP); Yoshihiro FUKAGAWA, Kanagawa (JP); Satoshi SASAKI, Kanagawa (JP)

(21) Appl. No.: 18/067,200

(22) Filed: Dec. 16, 2022

(30) Foreign Application Priority Data
Mar. 9, 2022 (JP) 2022036357

(51) Int. Cl. H04W 24/08; H04W 16/18

(52) U.S. Cl. CPC H04W 24/08; H04W 16/18

(57) ABSTRACT

The local 5G monitoring system includes measuring devices that measure radio waves from a base station of a local 5G system, and a server device that collects measurement data from the measuring devices, in which the server device uses the measurement data from the measuring devices when installation of the local 5G system is completed, as reference information, and determines that an abnormal state occurs, when the measurement data from the measuring devices during an operation of the local 5G system exceeds a threshold from the reference information.

### TECHNICAL FIELD

The present invention relates to a local 5G monitoring system for monitoring the operational performance of a local 5G system.

### BACKGROUND ART

Local 5G systems have been provided in which by using the various techniques used in the fifth generation mobile communication system (hereinafter also referred to as “5G”), organizations (local governments, companies, or the like) that are not telecommunications carriers have facilities and uses the facilities for exclusively providing services on land it owns or as self-employed communication facilities. Note that the local 5G system is sometimes called a private 5G system.

After such a local 5G system is installed in the user's actual field, in subsequent operations, abnormal states such as a decrease in a transmission speed or communication delay may occur due to factors such as equipment failure or stoppage and radio interference.

Unlike a network configuration using a relatively inexpensive wireless local area network (LAN), the local 5G system is an expensive system that emphasizes large capacity and low delay, and a time when abnormal states such as a decrease in a transmission speed or communication delay occur needs to be kept extremely short.

Patent Document 1 describes estimating factors that affect radio wave reception of a wireless LAN based on location information, radio wave information, spatial information, and peripheral information of each communication terminal, by arranging a plurality of communication terminals.

### RELATED ART DOCUMENT

### Patent Document

[Patent Document 1] JP-A-2020-141395

### DISCLOSURE OF THE INVENTION

### Problem that the Invention is to Solve

However, there is no system that monitors the operation of the local 5G system and makes a notification when an abnormal state occurs.

For this reason, even if the transmission speed of the local 5G system decreases or the communication delay occurs, it is difficult for the user to perceive these, and as a result of continuing operation without noticing, there is a problem that led to malfunctions of applications and services that require ultra-low delay and high reliability such as medical care and transportation using local 5G systems used by users.

Accordingly, an object of the present invention is to provide a local 5G monitoring system capable of detecting the occurrence of an abnormal state in a local 5G system.

### Means for Solving the Problem

A local 5G monitoring system according to the present invention is a local 5G monitoring system that monitors a local 5G system, and includes a measuring device that measures radio waves from a base station of the local 5G system, and a server device that collects measurement data from the measuring device, in which the server device uses the measurement data from the measuring device when installation of the local 5G system is completed, as reference information, and determines that an abnormal state occurs, when the measurement data from the measuring device during an operation of the local 5G system exceeds a threshold from the reference information.

With this configuration, the measurement data from the measuring devices when installation of the local 5G system is completed is used as the reference information, and it is determined that an abnormal state occurs when the measurement data from the measuring devices during am operation of the local 5G system exceeds a threshold from the reference information and deteriorates. Therefore, it is possible to detect the occurrence of an abnormal state based on the measurement data when the local 5G system was installed.

Further, in the local 5G monitoring system according to the present invention, the measuring device measures a state of Internet Protocol (IP) data communication in a wireless network of the local 5G system in addition to the radio waves, as the measurement data.

With this configuration, it is possible to detect an abnormal state of the IP data communication of the wireless network of the local 5G system, based on the measurement data when the local 5G system is installed.

Further, in the local 5G monitoring system according to the present invention, when detecting that the abnormal state occurs, the server device notifies a user of the detection.

With this configuration, the user is notified when it is detected that an abnormal state has occurred. Therefore, it is possible to quickly respond to an abnormal state.

Further, an abnormal state detection method according to the present invention is an abnormal state detection method of a local 5G monitoring system that includes a measuring device that measures radio waves from a base station of a local 5G system, and monitors the local 5G system, the method including a step of using measurement data acquired by the measuring device when installation of the local 5G system is completed, as reference information; and a step of determining that an abnormal state occurs, when the measurement data from the measuring device during an operation of the local 5G system exceeds a threshold from the reference information.

With this configuration, the measurement data from the measuring devices when installation of the local 5G system is completed is used as the reference information, and it is determined that an abnormal state occurs when the measurement data from the measuring devices during am operation of the local 5G system exceeds a threshold from the reference information and deteriorates. Therefore, it is possible to detect the occurrence of an abnormal state based on the measurement data when the local 5G system was installed.

Further, in the abnormal state detection method of the present invention, the measuring device measures a state of Internet Protocol (IP) data communication in a wireless network of the local 5G system in addition to the radio waves, as the measurement data.

With this configuration, it is possible to detect an abnormal state of the IP data communication of the wireless network of the local 5G system, based on the measurement data when the local 5G system is installed.

Further, in the abnormal state detection method according to the present invention, when detecting that the abnormal state occurs, the server device notifies a user of the detection.

### Advantage of the Invention

The present invention can provide a local 5G monitoring system that can detect the occurrence of abnormal states in the local 5G system.

### BRIEF DESCRIPTION OF THE DRAWINGS

FIG. 1 is a schematic configuration diagram of a local 5G monitoring system according to an embodiment of the present invention.

FIG. 2 is a conceptual diagram of an abnormal state detection method for the local 5G monitoring system according to the embodiment of the present invention.

### BEST MODE FOR CARRYING OUT THE INVENTION

Hereinafter, a local 5G monitoring system according to an embodiment of the present invention will be described in detail with reference to the drawings.

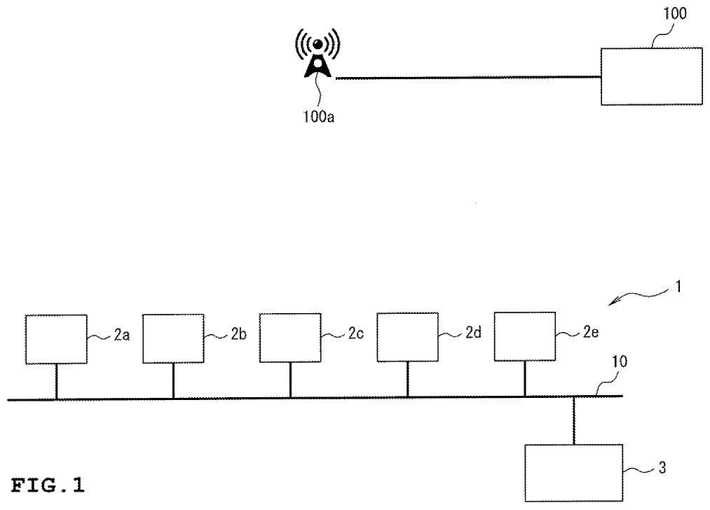

In FIG. 1, a local 5G monitoring system 1 according to an embodiment of the present invention is installed within the service area of a local 5G system 100.

The local 5G monitoring system 1 monitors the state of radio waves from the base station 100a of the local 5G system 100, the state of IP data communication in the wireless network of the local 5G system 100, and the like, and determines whether an abnormal state occurs.

The local 5G monitoring system 1 includes a plurality of measuring devices 2a, 2b, 2c, 2d, and 2e and a server device 3.

The measuring devices 2a, 2b, 2c, 2d, and 2e measure radio waves from the base station 100a of the local 5G system 100. The measuring devices 2a, 2b, 2c, 2d, and 2e measure IP data communication of the wireless network of the local 5G system 100. The measuring devices 2a, 2b, 2c, 2d, and 2e measure throughput, communication delay, or the like, as IP data communication measurements. As the measuring devices 2a, 2b, 2c, 2d, and 2e, mobile terminals that support 5G communication may be used in addition to normal measuring devices.

The server device 3 is a computer device. The computer devices each include a central processing unit (CPU), a read only memory (ROM), a random access memory (RAM), a non-volatile storage medium such as a hard disk device, various input/output ports, a display device, and an input device such as a pointing device or a keyboard device, which are not shown.

A program for controlling the computer device is stored in the ROM and hard disk device of the computer device. That is, the computer device performs the control of the present embodiment, by the CPU executing the programs stored in the ROM and the hard disk device using the RAM as a work area.

The server device 3 and the measuring devices 2a, 2b, 2c, 2d, and 2e are connected by a LAN 10 such that data can be transmitted and received to and from each other via the LAN 10. The server device 3 and the measuring devices 2a, 2b, 2c, 2d, and 2e may be connected via the Internet.

The server device 3 is connected to the Internet, and can transmit and receive e-mails and access social networking service (SNS) via the Internet.

In the present embodiment, the server device 3 uses the measurement data measured by the measuring devices 2a, 2b, 2c, 2d, and 2e when the local 5G system 100 is installed, as reference information, and makes a notification in a case where the measurement data measured by the measuring devices 2a, 2b, 2c, 2d, and 2e during the operation of the local 5G system 100 exceeds a threshold from the reference information and deteriorate.

In the local 5G system 100, the required throughput, communication delay, or the like is designed, the base station 100a, or the like is installed while performing measurement by the measuring devices 2a, 2b, 2c, 2d, and 2e so as to satisfy the designed throughput and communication delay, and when it is checked that the designed throughput and communication delay are satisfied, the installation is completed.

For example, when registration of reference information is selected by an input to the input device, the server device 3 stores the measurement data obtained by the measuring devices 2a, 2b, 2c, 2d, and 2e at the time of the selection, as the reference information, in the hard disk device.

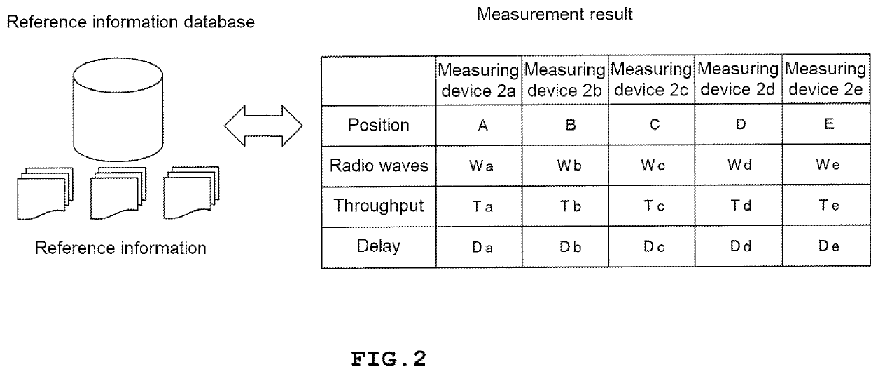

For example, as shown in FIG. 2, the server device 3 stores the measurement data measured by the measuring devices 2a, 2b, 2c, 2d, and 2e when the local 5G system 100 is installed, as reference information, in the reference information database. The reference information database is stored in the hard disk device of the server device 3, for example.

As the measurement data by the measuring devices 2a, 2b, 2c, 2d, and 2e, for example, as shown in FIG. 2, the state of radio waves (shown as “radio waves” in FIG. 2), throughput, delay, and the like are measured.

As the state of radio waves, for example, Reference Signal Received Power (RSRP), Reference Signal Received Quality (RSRQ), or the like are measured.

Throughput and delay are measured by communicating with, for example, a server device and a measuring device provided in the local 5G system 100.

The measuring devices 2a, 2b, 2c, 2d, and 2e, for example, perform wireless communication with a server device provided in the local 5G system 100 via the base station 100a to measure throughput and delay.

For example, the measuring devices 2a, 2b, 2c, 2d, and 2e transmit an “echo request” packet of Internet Control Message Protocol (ICMP) to the server device, and measure the wireless network delay of the local 5G system 100 by using time until an “echo reply” is returned from the server device (Round-Trip Time).

For example, the server device 3 compares the measurement data from the measuring devices 2a, 2b, 2c, 2d, and 2e with the reference information at predetermined time intervals, and determines that an abnormal state occurs, when the measurement data exceeds a threshold from the reference information and deteriorates.

For example, the server device 3 determines that an abnormal state occurs, when at least one of the RSRP values measured by the measuring devices 2a, 2b, 2c, 2d, and 2e exceeds a threshold from the reference information and is reduced.

For example, the server device 3 determines that an abnormal state occurs, when at least one of the throughputs measured by the measuring devices 2a, 2b, 2c, 2d, and 2e exceeds a threshold from the reference information and is reduced.

For example, the server device 3 determines that an abnormal state occurs, when at least one of the network delays measured by the measuring devices 2a, 2b, 2c, 2d, and 2e exceeds a threshold from the reference information and increases.

In addition, it is determined that it is abnormal in a case where the measurement data of at least one of the measuring devices 2a, 2b, 2c, 2d, and 2e exceeds a threshold from the reference information and deteriorates, but it may be determined that it is abnormal in a case where the measurement data of a predetermined number of measuring devices 2a, 2b, 2c, 2d, and 2e exceeds a threshold from the reference information and deteriorates.

Further, the threshold may be changed depending on the installation positions of the measuring devices 2a, 2b, 2c, 2d, and 2e.

When detecting that an abnormal state has occurred, the server device 3 notifies a user of the detection.

The server device 3 notifies the user by, for example, warning display on a display device or the like, alarm sound by a buzzer or the like, transmission of an e-mail, posting on an SNS, or the like.

Thus, in the above-described embodiment, the server device 3 uses the measurement data measured by the measuring devices 2a, 2b, 2c, 2d, and 2e when the local 5G system 100 is installed, as reference information, and determines that an abnormal state occurs, in a case where the measurement data measured by the measuring devices 2a, 2b, 2c, 2d, and 2e during the operation of the local 5G system 100 exceeds a threshold from the reference information and deteriorate.

Accordingly, it is possible to detect the occurrence of an abnormal state based on the measurement data when the local 5G system 100 was installed.

Further, when detecting that an abnormal state has occurred, the server device 3 notifies a user of the detection.

Thus, it is possible to notify the user of the occurrence of an abnormal state, and quickly respond to the abnormal state.

Although an embodiment of the present invention has been disclosed, it will be apparent that modifications may be made by those skilled in the art without departing from the scope of the present invention. All such modifications and equivalents are intended to be included in the following claims.

### DESCRIPTION OF REFERENCE NUMERALS AND SIGNS

1: Local 5G monitoring system
2a, 2b, 2c, 2d, 2e: Measuring device
3: Server device
100: Local 5G system
100a: Base station

What is claimed is:

1. A local 5G monitoring system that monitors a local 5G system, comprising:
a measuring device that measures radio waves from a base station of the local 5G system; and
a server device that collects measurement data from the measuring device, wherein
the server device uses the measurement data from the measuring device when installation of the local 5G system is completed, as reference information, and determines that an abnormal state occurs, when the measurement data from the measuring device during an operation of the local 5G system exceeds a threshold from the reference information.

2. The local 5G monitoring system according to claim 1, wherein
the measuring device measures a state of Internet Protocol (IP) data communication in a wireless network of the local 5G system in addition to the radio waves, as the measurement data.

3. The local 5G monitoring system according to claim 1, wherein
when detecting that the abnormal state occurs, the server device notifies a user of the detection.

4. An abnormal state detection method of a local 5G monitoring system that includes a measuring device that measures radio waves from a base station of a local 5G system, and monitors the local 5G system, the method comprising:
a step of using measurement data acquired by the measuring device when installation of the local 5G system is completed, as reference information; and
a step of determining that an abnormal state occurs, when the measurement data from the measuring device during an operation of the local 5G system exceeds a threshold from the reference information.

5. The abnormal state detection method according to claim 4, wherein
the measuring device measures a state of Internet Protocol (IP) data communication in a wireless network of the local 5G system in addition to the radio waves, as the measurement data.

6. The abnormal state detection method according to claim 4, wherein
when detecting that the abnormal state occurs, the server device notifies a user of the detection.
